(19) United States
(12) Patent Application Publication
(10) Pub. No.: US 2003/0145300 A1
(43) Pub. Date: Jul. 31, 2003

(54) Layout tracking solutions

(76) Inventor: Trung M. Tran, Round Rock, TX (US)

Correspondence Address: BLAKELY, SOKOLOFF, TAYLOR & ZAFMAN LLP, Seventh Floor, 12400 Wilshire Boulevard, Los Angeles, CA, 90025-1030, US

(21) Appl. No.: 10/059,592

(22) Filed: Jan. 28, 2002

(51) Int. Cl. G06F 9/455; G06F 17/50

(52) U.S. Cl. 716/11

(57) ABSTRACT

Disclosed are novel methods and apparatus for efficiently providing layout tracking solutions. In an embodiment, a method of tracking a plurality of cell layouts is disclosed. The method includes dividing a circuit layout design into a plurality of cell; providing a list of the plurality of cells; permitting a user to select a cell from the list of cells; permitting the user to enter cell information for the selected cell; providing a first data structure and a second data structure, the first data structure including cellname information regarding the selected cell and the second data structure including cell information for the selected cell; and sequentially storing the entered cell information for the selected cell from the first and second data structures. It is envisioned that the sequentially stored cell information provides data on a status of the plurality of cell layouts.

### FIELD OF INVENTION

The subject of this application relates generally to the field of integrated circuit (IC) design, and more particularly to layout tracking solutions.

### BACKGROUND OF INVENTION

As IC fabrication technology improves, manufacturers are able to integrate additional functionality onto a single silicon substrate. As the number of these functions increases, however, so does the complexity of the designs. Often to meet deadlines, many designers work on a same design simultaneously. The partial designs will then need to be put together to make a final product. The timing is of the essence in making sure that the many portions of the design are finished relatively simultaneously. Also, it is imperative that strict deadlines are followed, in part, because a later design stage may depend on information regarding a preceding stage before meaningful design may be commenced.

As circuits are quickly becoming more complicated, layout tracking, as with many other design scheduling techniques, is becoming increasingly computerized for efficiency purposes. Also, as circuit designs grow in complexity, it is imperative to decrease the number of computer resources and hours spent on tracking these design layouts. This is extremely important with respect to layout tracking. Especially, in the current climate of competition, it is imperative that the layout tracking be performed accurately such that designers' time is not wasted in waiting for completion of a previous design stage.

FIG. 1 illustrates an exemplarily flow diagram of a typical design process 100 for ICs in accordance with the prior art. The process can be generally divided into a front end design phase and a back end development phase. During the front end phase, an engineer designs and develops a logical representation of an IC from a set of specifications in form of a schematic (step 102). At a step 104, the schematic is then loaded into a computer from which a circuit netlist is generated. The netlist defines the entire IC design including all components and interconnections.

Moreover, the IC information may be developed using hardware description language (HDL) and synthesis. With the aid of circuit simulation tools available on computers, a designer can then simulate the functionality of a given circuit at a step 106. The circuit simulation process may involve several iterations of design modifications and improvements, until the circuit design is finalized at a step 108.

The back end development involves several steps during which a final circuit layout (physical description) is developed based on the schematic design of the front end. In a step 110, various building blocks (or cells), as defined by the finalized circuit schematic, are placed within a predefined floor plan. For ICs designed based on array or standard cell technology, the various building circuit blocks are typically predefined and made available in a cell library. For example, during the step 110, a plurality of cells are selected from one or more cell libraries and the cell interconnects are determined. More particularly, groups of cells may be interconnected to function as a flip-flop, shift registers, and the like. The routing of wires to interconnect the cells and achieve the aforementioned goals is preformed during a routing step 112, typically referred to as conducting paths, wires or nets. Accordingly, in the step 112, interconnects between circuit elements are routed throughout the layout. In a step 114, the accuracy of the layout is verified against the schematic and if no errors or design rule violations are found at a step 116, the circuit layout information is used for the process of fabrication in a step 118.

### SUMMARY OF INVENTION

The present invention, which may be implemented on a general-purpose digital computer, includes novel methods and apparatus to provide layout tracking solutions, utilizing single or multiple processors.

In an embodiment, a method of tracking a plurality of cell layouts is disclosed. The method includes dividing a circuit layout design into a plurality of cell; providing a list of the plurality of cells; permitting a user to select a cell from the list of cells; permitting the user to enter cell information for the selected cell; providing a first data structure and a second data structure, the first data structure including cellname information regarding the selected cell and the second data structure including cell information for the selected cell; and sequentially storing the entered cell information for the selected cell from the first and second data structures. It is envisioned that the sequentially stored cell information provides data on a status of the plurality of cell layouts. In various embodiments the first data structure and/or the second data structure can be linked list.

In another embodiment, a graphical user interface (GUI) for tracking status of a plurality of layout cells is disclosed. The GUI includes a first frame including a name list of a plurality of cells being tracked; a second frame including a plurality of fields to enter data for a selected cell from the name list; a third frame to include comments regarding the selected cell; and a fourth frame to include a message regarding the selected cell. In certain embodiments, the GUI further includes a plurality of buttons.

### BRIEF DESCRIPTION OF DRAWINGS

The present invention maybe better understood and it's numerous objects, features, and advantages made apparent to those skilled in the art by reference to the accompanying drawings in which:

FIG. 1 illustrates an exemplarily flow diagram of a typical design process 100 for ICs in accordance with the prior art;

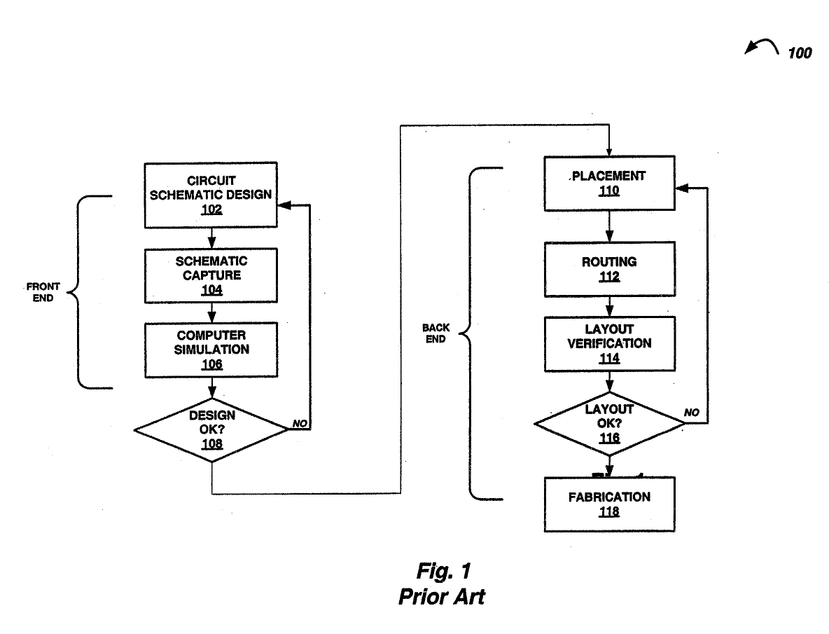

FIG. 2 illustrates an exemplary computer system 200 in which the present invention may be embodied;

FIG. 3 illustrates an exemplary tool 300 in accordance with an embodiment of the present invention; and

FIG. 4 illustrates an exemplary report 400 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

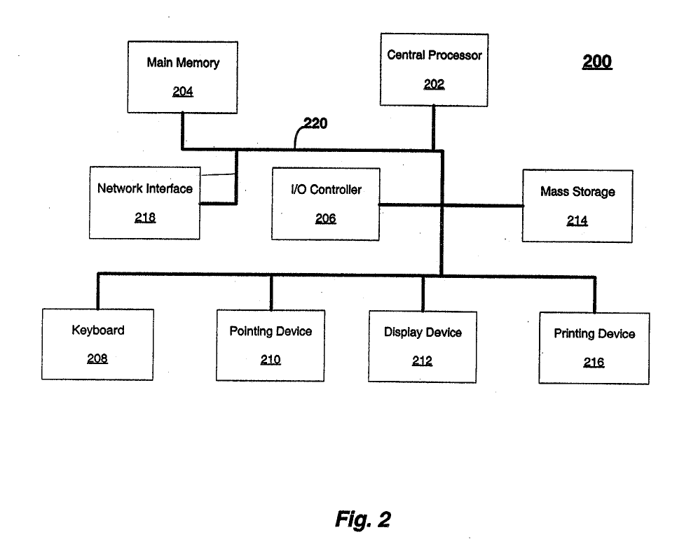

FIG. 2 illustrates an exemplary computer system 200 in which the present invention may be embodied in certain embodiments. The system 200 comprises a central processor 202, a main memory 204, an input/output (I/O) controller 206, a keyboard 208, a pointing device 210 (e.g., mouse, track ball, pen device, or the like), a display device 212, a mass storage 214 (e.g., hard disk, optical drive, or the like), and a network interface 218. Additional input/output devices, such as a printing device 216, may be included in the system 200 as desired. As illustrated, the various components of the system 200 communicate through a system bus 220 or similar architecture.

In an embodiment, the computer system 200 includes a Sun Microsystems computer utilizing a SPARC microprocessor available from several vendors (including Sun Microsystems of Palo Alto, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations.

The network interface 218 provides communication capability with other computer systems on a same local network, on a different network connected via modems and the like to the present network, or to other computers across the Internet. In various embodiments, the network interface 218 can be implemented in Ethernet, Fast Ethernet, wide-area network (WAN), leased line (such as T1, T3, optical carrier 3 (OC3), and the like), digital subscriber line (DSL and its varieties such as high bit-rate DSL (HDSL), integrated services digital network DSL (IDSL), and the like), time division multiplexing (TDM), asynchronous transfer mode (ATM), satellite, cable modem, and FireWire. Moreover, the computer system 200 may utilize operating systems such as Solaris, Windows (and its varieties such as NT, 2000, XP, ME, and the like), HP-UX, IBM-AIX, Unix, Berkeley software distribution (BSD) Unix, Linux, Apple Unix (AUX), and the like. Also, it is envisioned that in certain embodiments, the computer system 200 is a general purpose computer capable of running any number of applications such as those available from companies including Oracle, Siebel, Unisys, Microsoft, Vignette, IBM, Avanti, Synopsis, and the like.

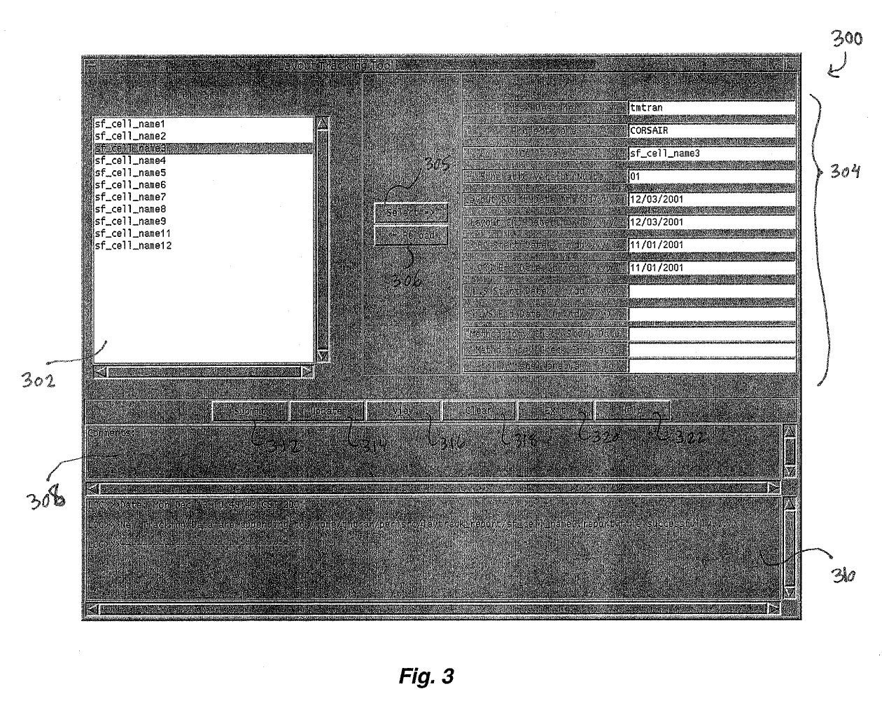

FIG. 3 illustrates an exemplary tool 300 in accordance with an embodiment of the present invention. The tool 300 can in some embodiments be used to help mass designers, their project managers, or more generally a user in recording and tracking layout work schedules. It is envisioned that each mass designer is generally assigned a cell (or a group of cells) for a given project. Each cell is envisioned to contain layout information about a portion of a given design. Also, cells may be divided such that each cell can be assigned to a given designer who can individually complete the task of providing the layout for that cell.

As illustrated, the tool 300 includes four frames. The first frame (cellname list 302) is utilized to obtain a list of cells from a responsible party such as a mass designer. It is envisioned that the designed can specify the cell list either by creating a file and adding each cellname to that file or creating subdirectories with the names matching the cellnames. The second frame (mass designer inputs 304) is utilized to allow a designer (or other appropriate user) access for entering the required data for a given cellname. A button 305 may be utilized to load information regarding a selected cellname from the cellname list 302 into the mass designer inputs frame 304. A button 306 may be utilized to reload the cellname list data into the cellname list 302. It is also envisioned that the reload button 306 can be utilized to allow a user to reload the cellname list from, for example, a file stored on a computer system or a server (locally and/or remotely) while running the tool 300. This feature is supported to allow users to refresh or update the list 302 without terminating the tool 300.

As illustrated in FIG. 3, the inputs for the mass designers inputs frame 304 may include a mass designer's name, a project name, a cellname, a schematic version number, a layout start date, a layout end date, a design rule check (DRC) start date, a DRC end date, a layout verses schematic (LVS) start date, and LVS end date, methodology check start date, a methodology check end date, and a miscellaneous information field. It is envisioned that fewer or more fields may be utilized to provide mass designer inputs frame 304 depending on the issues being addressed.

The third frame (comments 308) can be utilized to allow a user to enter general comments such as messages regarding a given cellname that may need to be communicated to other personal involved in the project or as a reminder to the user. The fourth frame (message 310) is utilized to display messages created by the system including those created by the tool 300. It is also envisioned that the frames discussed herein (and more generally any fields discussed herein) may be scrollable in X, Y, and Z axes.

The tool 300 may also provide access to other functionality such as those illustrated in FIG. 3 as buttons 312-322. The submit button 312 allows a user to submit the input provided to generate a report. The update button 314 allows a user to store the data entered into the mass designer inputs frame (304) to a nonvolatile memory. The view button 316 permits a user to generate a viewable report of the available cell information. The clear button 318 can be utilized to clear all the messages provided in the message frame 310. The exit button 320 can be utilized to terminate the tool 300. The help button 322 can provide access to information, which may assist a user in utilizing the tool 300 and its functionalities.

When inputs are obtained and the submit button is pressed, it is envisioned that all the data input are added to a first linked list where all the cellnames can be linked to. Each cell defined in the linked list can also be defined as a linked list itself where all user inputs can be stored. Having used these two linked lists, a user can submit multiple runs for the same cell without causing performance concerns. It is envisioned that once a layout job is done, a user can click on the exit button 320 and all the data from the linked list can be written to a file. Therefore, data can be stored and organized in a sequential fashion. It is also envisioned that the tool 300 has an advantage of avoiding opening and closing the same file multiple times. This is an especially important performance consideration because opening and closing files generally degrades the performance of a computer system due, in part, to the required wait periods for reading and writing files.

It is also envisioned that once the exit button 320 is pressed, a file can be generated to store the selected cellname. Therefore, if a user happens to exit the tool 300 and reload it, the last selected cellname will be retrieved from the stored file. It is also envisioned that a user may click on the view button 316 to import the stored report data into an appropriate application for further formatting, sorting, and the like. An example of such an application is StarOffice by Sun Microsystems, Inc., of Palo Alto, Calif., Excel by Microsoft Corporation of Redmond, Wash., and Lotus 123 by IBM. Advantages of implying a link list configuration with the tool 300 include no limitation on the number of entries, temporary storage of data without having to open and save a file, providing a non-fragmented file, and utilization of system resources such as an exception handler provided in, for example, Solaris systems by Sun Microsystems, which would save any unrecorded data prior to an involuntary termination of a program (such as the tool 300).

It is further envisioned that different data structures may be utilized to store the cellnames discussed with respect to the current invention. For example, the cell information may be stored in a library, cell, and/or view configuration where the library is a directory name (parent), the cell is a subdirectory of library (child), and the view is a subdirectory of cell (grandchild, where all the actual binary data that contains a design may reside). Thus, a hierarchical structure may be utilized to store and/or organize the actual data for a design.

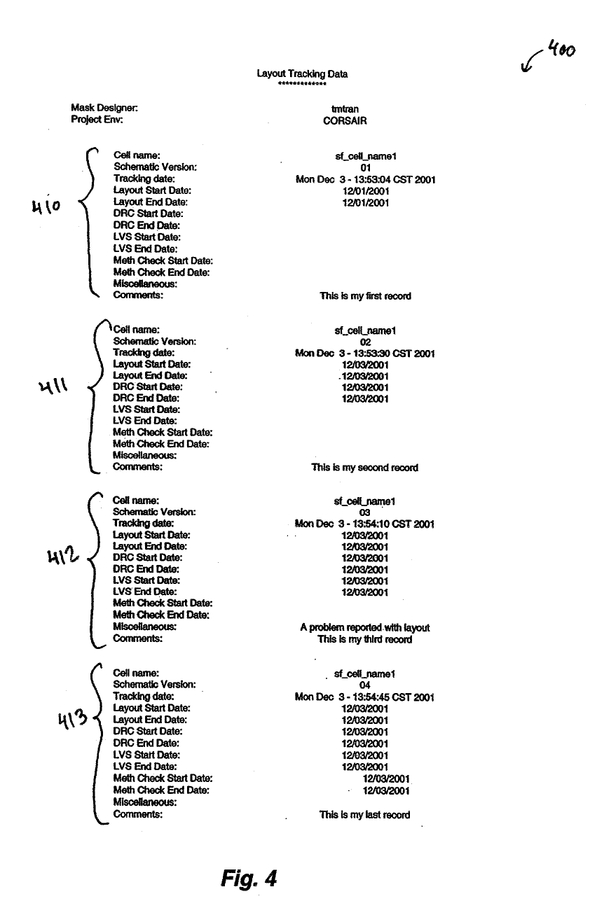

FIG. 4 illustrates an exemplary report 400 in accordance with an embodiment of the present invention. As illustrated, the report 400 includes information about a same cellname (sf_cell_name1). Report sections 410-413 include the cell information in a chronological order. The information provided in sections 410-413 are, in the most part, similar to those entered by a user in the mass designers frame 304 of FIG. 3. As shown, the report sections 410-413 also include a tracking date field (optional) which can track the exact date and time of when the data was entered into a tool such as the tool 300 of FIG. 3. It is envisioned that the cell information can be stored in sequential manner such that different user inputs for a given cell are recorded to ensure that the report reflects accurate tracking of changes associated with a given cell.

The foregoing description has been directed to specific embodiments. It will be apparent to those with ordinary skill in the art that modifications may be made to the described embodiments, with the attainment of all or some of the advantages. For example, the schemes, data structures, and methods described herein can also be extended to other applications. Also, while the techniques disclosed herein have been discussed with respect to mass designers, they could equally be applied to a general computer user. Therefore, it is the object of the appended claims to cover all such variations and modifications as come within the spirit and scope of the invention.

What is claimed is:

1. A method of tracking a plurality of cell layouts, the method comprising:
dividing a circuit layout design into a plurality of cells;
providing a list of the plurality of cells;
permitting a user to select a cell from the list of cells;
permitting the user to enter cell information for the selected cell;
providing a first data structure and a second data structure, the first data structure including cellname information regarding the selected cell and the second data structure including cell information for the selected cell; and
sequentially storing the entered cell information for the selected cell from the first and second data structures,
wherein the sequentially stored cell information provides data on a status of the plurality of cell layouts.

2. The method of claim 1 wherein the first data structure is a linked list.

3. The method of claim 1 wherein the second data structure is a linked list.

4. The method of claim 1 wherein the cell information is selected from a group comprising a designer's name, a project name, a cellname, a schematic version number, a layout start date, a layout end date, a DRC start date, a DRC end date, an LVS start date, an LVS end date, a methodology check start date, a methodology check end date, and miscellaneous information.

5. The method of claim 1 wherein the first data structure includes cellname information for a plurality of selected cells from the plurality of cells.

6. The method of claim 1 further including importing the sequentially stored cell information into a spreadsheet application to provide formatted data on a status of the plurality of layouts.

7. The method of claim 6 wherein the spreadsheet application is selected from a group comprising Excel, StarOffice, and Lotus 123.

8. The method of claim 1 wherein the list of the plurality of cells is stored in a file and the file is imported into a tool to permit the user to select a cell from the list of cells.

9. The method of claim 1 wherein the list of the plurality of cells is stored in a file and the file is imported into a tool to permit the user to enter cell information for the selected cell.

10. The method of claim 9 wherein the file is stored on a remote server.

11. A graphical user interface (GUI) for tracking status of a plurality of layout cells, the GUI comprising:
a first frame including a name list of a plurality of cells being tracked;
a second frame including a plurality of fields to enter data for a selected cell from the name list;
a third frame to include comments regarding the selected cell; and
a fourth frame to include a message regarding the selected cell.

12. The GUI of claim 11 further including a plurality of buttons.

13. The GUI of claim 12 wherein the plurality of buttons are selected from a group comprising select, reload, submit, update, view, clear, exit, and help.

14. The GUI of claim 11 wherein at least one of the first, second, third, and fourth frames are scrollable.

15. The GUI of claim 11 wherein the scrollable frame is scrollable in X, Y, and Z axes.

16. An article of manufacture comprising:
a machine readable medium that provides instructions that, if executed by a machine, will cause the machine to perform operations including:
dividing a circuit layout design into a plurality of cells;
permitting a user to select a cell from the plurality of cells;
permitting the user to enter cell information for the selected cell;
providing a first data structure and a second data structure, the first data structure including cellname information regarding the selected cell and the second data structure including cell information for the selected cell; and
sequentially storing the entered cell information for the selected cell from the first and second data structures.

17. The article of claim 16 wherein the operations further include importing the sequentially stored cell information into a spreadsheet application to provide formatted data on a status of the plurality of layouts.

18. The article of claim 16 wherein at least one of the first and second data structures is implemented utilizing linked lists.

19. An apparatus comprising:
a divider to divide a circuit layout design into a plurality of cells;
a first facility to permit a user to select a cell from the plurality of cells;
a second facility to permit the user to enter cell information for the selected cell;
a third facility to provide a first data structure and a second data structure, the first data structure including cellname information regarding the selected cell and the second data structure including cell information for the selected cell; and
a storage unit to sequentially store the entered cell information for the selected cell from the first and second data structures.

20. The apparatus of 19 further including an importing facility to import the sequentially stored cell information into a spreadsheet application to provide formatted data on a status of the plurality of layouts.

21. The apparatus of claim 19 wherein at least one of the first and second data structures is implemented utilizing linked lists.

22. The apparatus of claim 19 wherein the cell information is selected from a group comprising a designer's name, a project name, a cellname, a schematic version number, a layout start date, a layout end date, a DRC start date, a DRC end date, an LVS start date, an LVS end date, a methodology check start date, a methodology check end date, and miscellaneous information.

23. The apparatus of claim 19 wherein the first data structure includes cellname information for a plurality of selected cells from the plurality of cells.

24. The apparatus of claim 19 further including a remote server to store a list of the plurality of cells.

25. An apparatus comprising:
dividing means to divide a circuit layout design into a plurality of cells;
first permission means to permit a user to select a cell from the plurality of cells;
second permission means to permit the user to enter cell information for the selected cell;
a first data structure and a second data structure, the first data structure including cellname information regarding the selected cell and the second data structure including cell information for the selected cell; and
storage means to sequentially store the entered cell information for the selected cell from the first and second data structures.

26. The apparatus of 25 further including importing means to import the sequentially stored cell information into a spreadsheet application to provide formatted data on a status of the plurality of layouts.
